(19) United States
(12) Patent Application Publication
(10) Pub. No.: US 2008/0302195 A1
(43) Pub. Date: Dec. 11, 2008

(54) Reverse shift jump out of gear fix for model T45, 5 speed manual automotive transmission

(76) Inventor: Dick Patrick McCord, Maryville, TN (US)

Correspondence Address: Dick P. McCord, 3721 Mint Road, Maryville, TN, 37803, US

(21) Appl. No.: 11/811,419

(22) Filed: Jun. 11, 2007

(51) Int. Cl. F16H 3/00

(52) U.S. Cl. 74/325

(57) ABSTRACT

The invention described herein is the first known solution to modify the original model T45 manual transmission to prevent or fix the documented reverse shift problems inherit in the original production design as described in the Background of the Invention section included in this application.

### CROSS-REFERENCE TO RELATED APPLICATIONS

N/A

### STATEMENT REGARDING FEDERALLY SPONSORED RESEARCH

N/A

### REFERENCE TO SEQUENCE LISTING, TABLE, OR COMPUTER PROGRAM LISTING CD APPENDIX

N/A

### BACKGROUND OF THE INVENTION

The 5 speed manual automotive transmission model T45 was originally designed and produced by Borg-Warner Automotive, sold to Ford Motor Company, and installed in Ford Mustang 4.6 L V-8 engine applications for the vehicle model years 1996 thru 2001. The T45 transmission suffered from an inherit design issue that resulted in a problem condition of: 1) being stuck in reverse gear; 2) being difficult to shift into reverse gear; or 3) jumping out of reverse gear. This problem issue is documented in Ford Technical Service Bulletin #TSB #01235, (NHTSA ID#630341 dated Nov. 26, 2001).

The basic problem to be fixed involves overcoming the inability of the original double disconnect design shift system components to maintain a synchronized movement of the reverse shifting sleeves (2) located on both the output and counter shafts. To complete a properly synchronized reverse shift sequence, the tooth points of the reverse shifting sleeve must engage the clutching teeth of the reverse driven gear located on the output shaft simultaneously with the tooth points of the 5/Rev shifting sleeve tooth points engaging the clutching teeth of the reverse drive gear located on the counter shaft.

Due to tolerance stackup of multiple components, excessive wear of components, or deflection of shifting fork, the simultaneous engagement of tooth points with clutching teeth on both shafts is not able to be completed on every shift event. Without the required simultaneous travel engagement, the relative rotational speed of sleeve tooth points to gear clutch teeth will create unsynchronized engagement at the tooth point surfaces resulting in excessive wear and cumulative damage to the tooth contact surfaces. Once the damage exceeds acceptable operational limits, the reverse shift system is subject to exhibiting the problems described above.

### BRIEF SUMMARY OF THE INVENTION

The object of the invention is to provide a reverse shifting problem fix for the model T45 manual transmission by modification of the original reverse shift system components to eliminate the requirement for synchronized movement of the (2) shifting sleeves. Specifically, the modification included in the invention creates a permanent engagement of the reverse driven gear to the output shaft eliminating (1) shifting sleeve and provides for full operation of the reverse shift system with the remaining shifting sleeve.

### BRIEF DESCRIPTION OF THE SEVERAL VIEWS OF THE DRAWING

FIG. 1 Original Double Disconnect Reverse Shift System

FIG. 2 Reverse Jumpout Fix Invention Reverse Shift System

FIG. 3a Original Components

FIG. 3b Invention Modified Components

FIG. 4 Original System in Neutral Position—Left Side View

FIG. 5 Original System in Reverse Position—Left Side View

FIG. 6 Invention System—Left Side View

FIG. 7 Original System in Neutral Position—Right Side View

FIG. 8 Original System in Reverse Position—Right Side View

FIG. 9 Original System in 5th Position'Right Side View

FIG. 10 Invention System in Neutral Position—Right Side View

FIG. 11 Invention System in Reverse Position—Right Side View

FIG. 12 Invention System in 5th Position—Right Side View

### DETAILED DESCRIPTION OF THE INVENTION

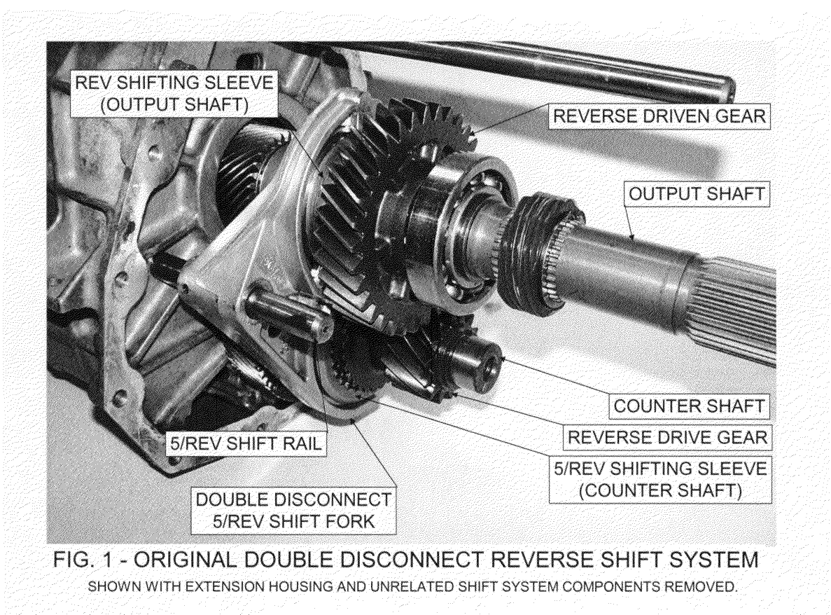

The original T45 manual transmission was released for production incorporating a uniquely designed double disconnect reverse shift system as shown in Fig.1. Rev hub, reverse shifting sleeve, 5th driven gear, and reverse driven gear are located on the output shaft. The 5/Rev synchronizer assembly with 5/Rev shifting sleeve, 5th drive gear, and reverse drive gear are located on the counter shaft. The (2) shifting sleeves are positioned axially by movement of the double disconnect shift fork which is pinned to the 5/Rev shift rail. The 5/Rev shift rail is moved axially fore and aft to change gear selections through the response of the transmission shifting system that is controlled by the driver by means of normal shifting of an automotive manual transmission and the relative positioning of the shifter lever.

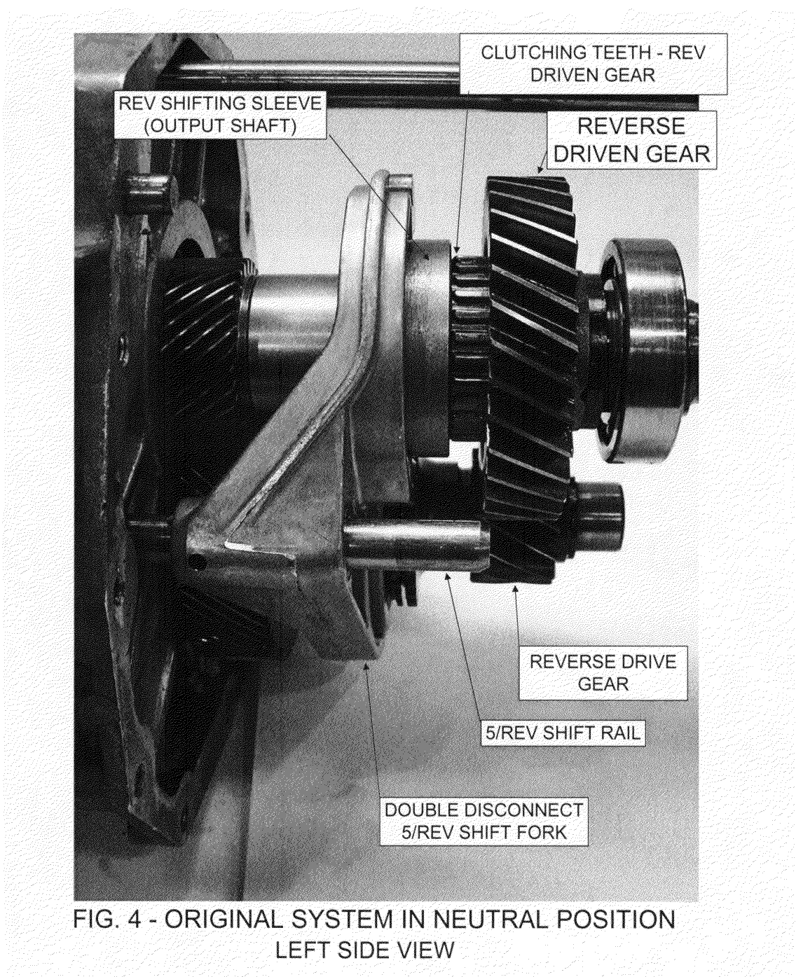

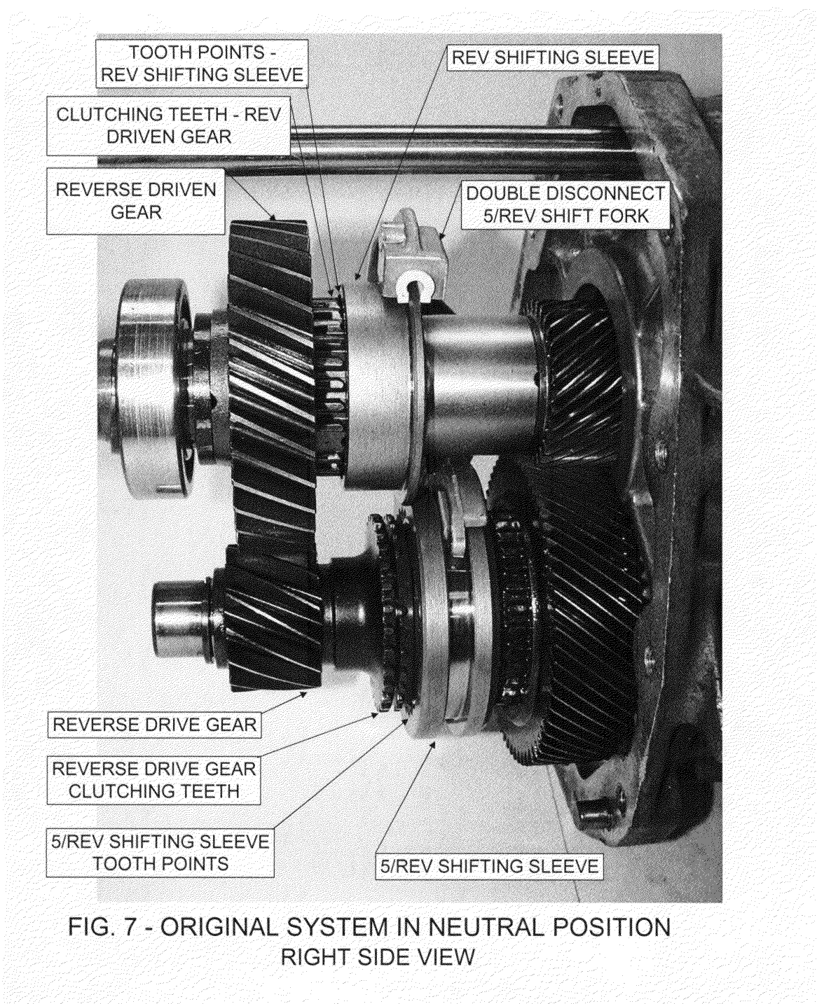

FIG. 4 provides a left side view and FIG. 7 provides a right side view of the original system in Neutral position. In Neutral position, neither reverse gear or 5th gear are engaged. The reverse shifting sleeve on output shaft is not engaged with the clutching teeth of the reverse driven gear and the 5/Rev shifting sleeve on the counter shaft is not engaged with the clutching teeth of the reverse drive gear. Both the reverse drive gear and the reverse driven gear are free to rotate about their mounting shafts independently from the rotation of the output shaft. This is the orientation of the reverse shift system when the transmission shift lever is placed in the Neutral position or into any other shift position (1st through 4th) except reverse or 5th. Reverse and 5th shift orientations are described in the following two paragraphs.

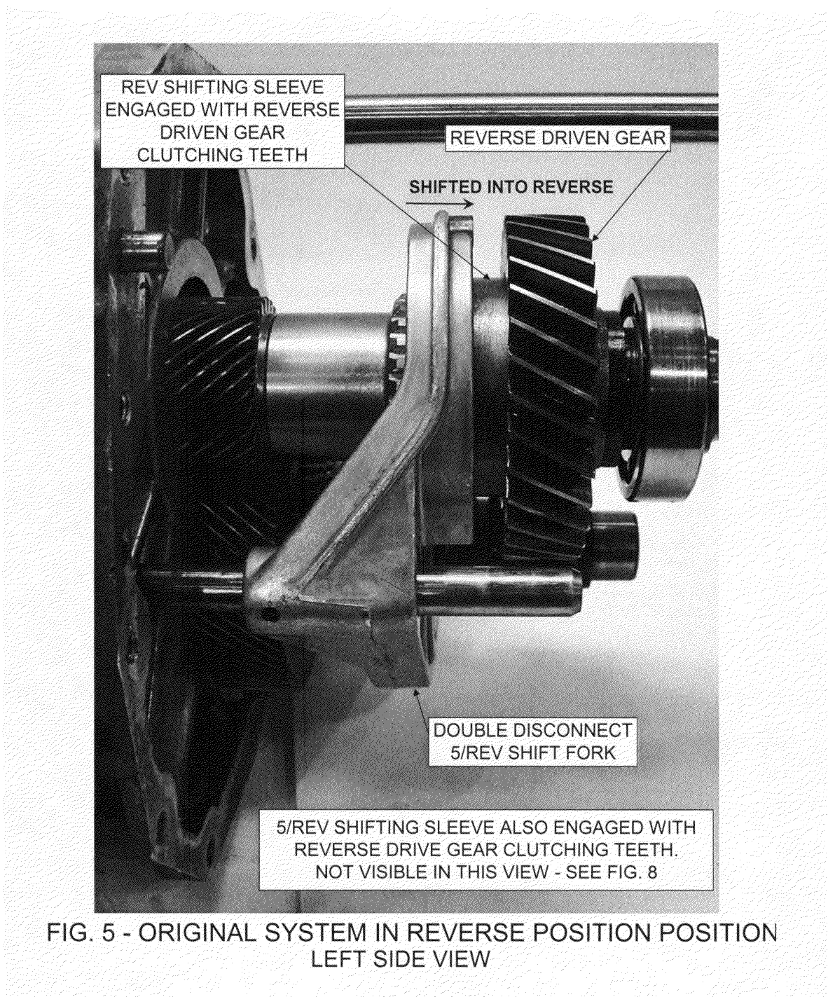

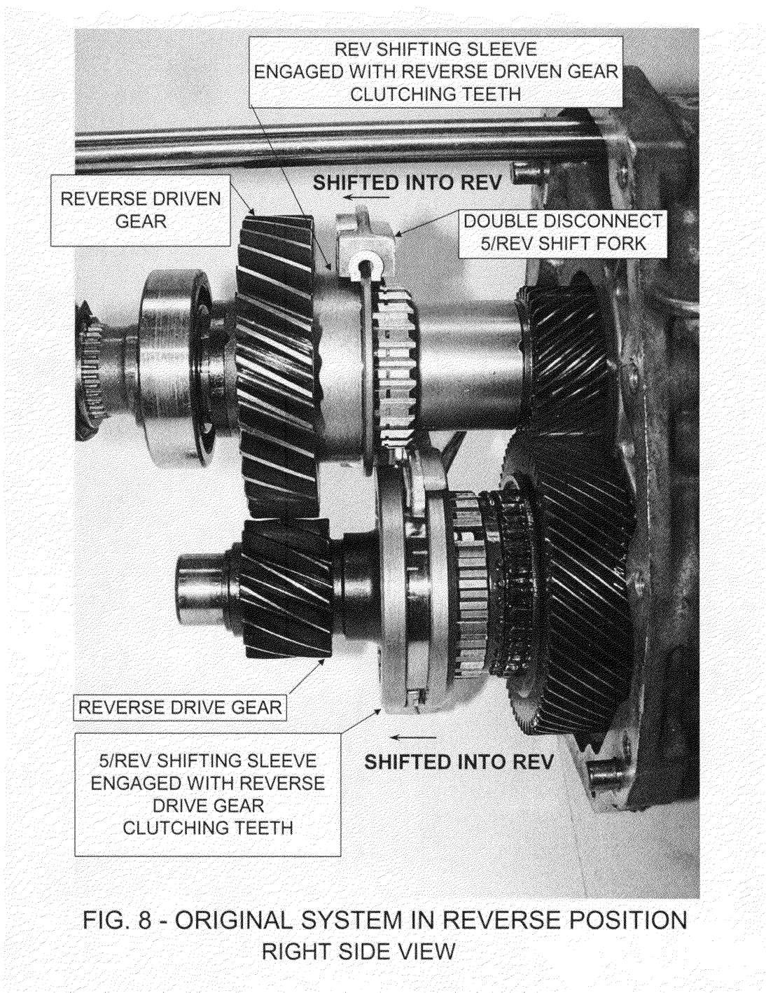

FIG. 5 provides a left side view of the original system shifted into the reverse engaged position. When shifted into reverse, the 5/Rev shift rail moves the double disconnect shift fork rearward which simultaneously slides the reverse shifting sleeve tooth points to engage the clutching teeth of the reverse driven gear and also slides the 5/Rev shifting sleeve tooth points rearward to engage the clutching teeth of the reverse drive gear. FIG. 8, the right side view, more clearly illustrates the position of the shift system components. With the reverse position engaged, the output shaft rotation is directly connected through the reverse geartrain mesh being driven through the reverse drive gear on the counter shaft.

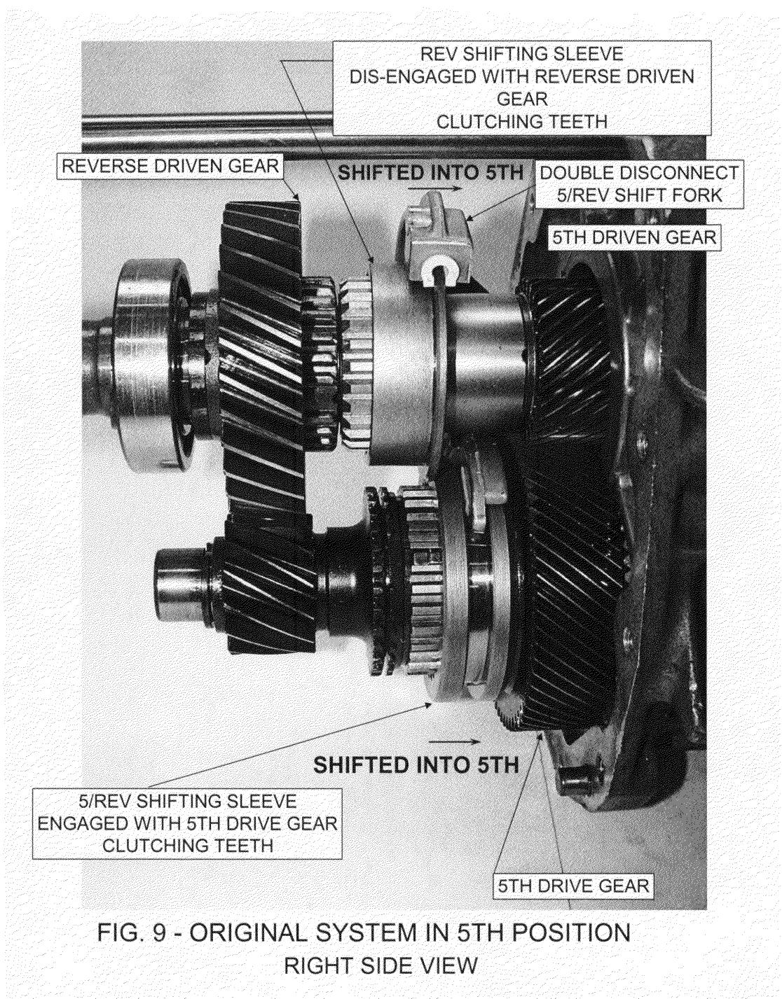

FIG. 9 provides a right side view of the original system shifted into the 5th engaged position. When shifted into 5th, the 5/Rev shift rail moves the double disconnect shift fork forward which simultaneously slides the reverse shifting sleeve forward and also slides the 5/Rev shifting sleeve tooth points forward to engage the clutching teeth of the 5th drive gear. With the 5th position engaged, the output shaft rotation is directly connected through the 5th geartrain mesh being driven through the 5th drive gear on the counter shaft.

Proper operation of the reverse and 5th shift systems relies on synchronization of the rotational speed of the input side of the gear mesh with the output side shaft rotational speed. A discussion of the operation of the 5/Rev synchronizer assembly is beyond the scope of this patent application. However, a portion of the synchronization process includes the interaction and indexing rotation of the tooth point chamfers of the shifting sleeve working against the corresponding tooth point chamfers on the clutching teeth of the drive or driven gear. Once the rotational speeds are synchronized, the shifting sleeve moves past the tooth point chamfers into final engagement and the sleeve becomes torque locked by means of the back taper of the mating gear clutch teeth contacting and matching the back taper of the shifting sleeve teeth.

The unique aspect of the T45 double disconnect shift system is that (2) shifting sleeves are attempting to be synchronized simultaneously on both output and counter shafts for a completed reverse gear shift. Without the simultaneous travel engagement at tooth point chamfers of both shifting sleeves, the relative rotational speed of sleeve tooth point chamfers to gear clutch teeth chamfers will create unsynchronized engagement at the tooth point surfaces resulting in excessive wear and cummulative damage to the tooth contact surfaces. The driver will experience noise and shift lever feedback as the tooth points unsuccessfully attempt to engage and create a clash shift condition. Once the damage exceeds acceptable operational limits, the reverse shift system is no longer able to successfully synchronize input side and output shaft rotational speeds. When the back tapered sides of the clutching teeth are sufficiently damage experiencing noise and an immediate feedback in shift lever position.

To overcome the above described shift problems, the driver can apply additional force to the shift lever to effectively override the shift system feedback and force the shift system to remain located in the engaged position to prevent the shifting sleeve from jumping out of gear. Over time, the cumulative damage to shift fork or clutching teeth from this operation will result in breakage of these components with a shifting sleeve often being stuck in the reverse engaged position. With the driver unable to disengage the reverse shifting sleeve(s), the transmission will remain stuck in reverse gear and will require removal from the vehicle to affect a repair.

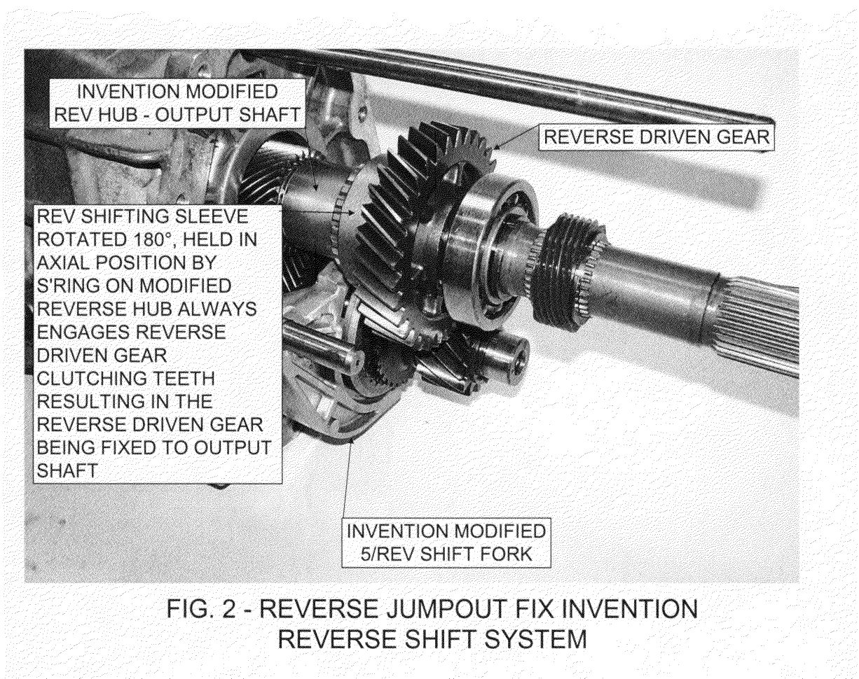

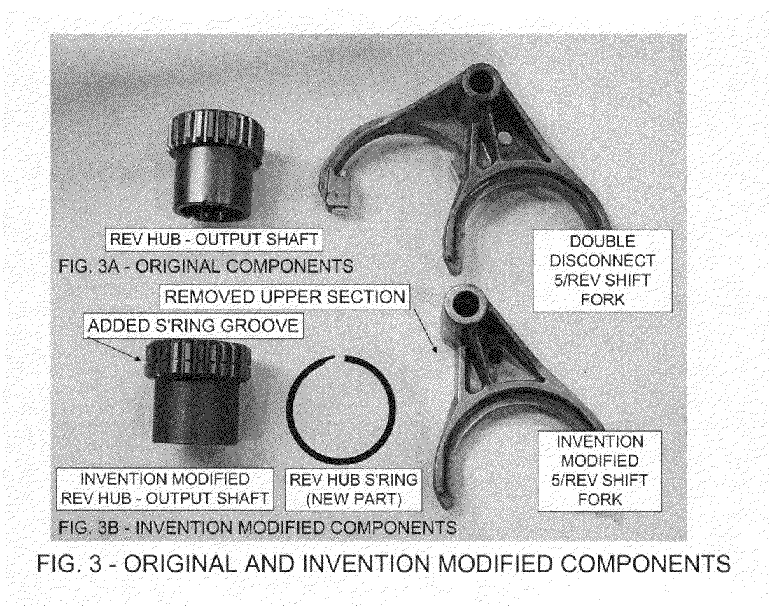

The invention system for fixing the T45 manual transmission reverse jump out of gear problem is shown in FIG. 2. The 5/Rev shift fork and reverse hub have been modified from the original design shown in FIG. 1. In addition, the reverse shifting sleeve has been rotated 180° and is restrained from any movement in axial position by the new s'ring assembled onto the invention modified reverse hub. See FIG. 3 for a closer review of the modified parts. The original double disconnect shift fork has been modified by removing the upper section that interfaced with and positioned the reverse shifting sleeve located on the output shaft. For the invention system, the shift fork now only interfaces and positions the 5/Rev shifting sleeve located on the countershaft. The invention modified reverse hub has an added machined groove that is used to locate a new part, the reverse hub s'ring.

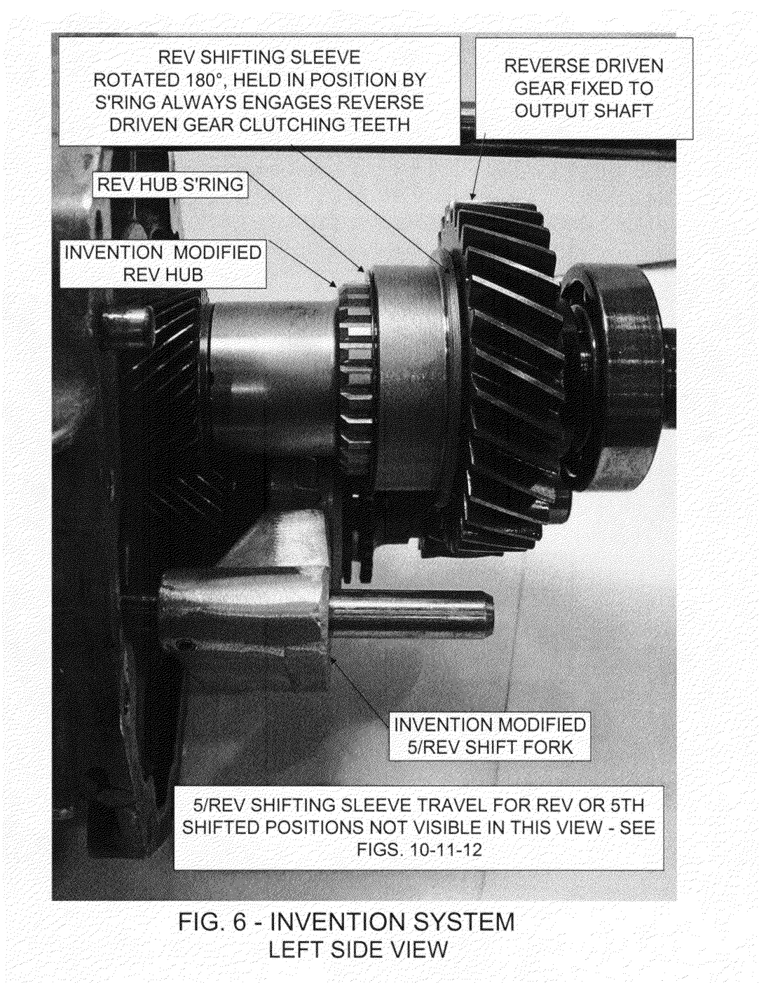

FIG. 6 provides a left side view of the invention system. The reverse shifting sleeve has been rotated 180° with the flanged end butted up against the face of the reverse driven gear. The clutching teeth of the reverse sliding sleeve are constantly engaged with the reverse hub splined teeth and the clutching teeth of the reverse driven gear by means of the reverse hub s'ring that restrains the sliding sleeve from sliding fore or aft. In effect, the reverse driven gear is fixed to the output shaft and therefore rotates at same speed as the output shaft at all times.

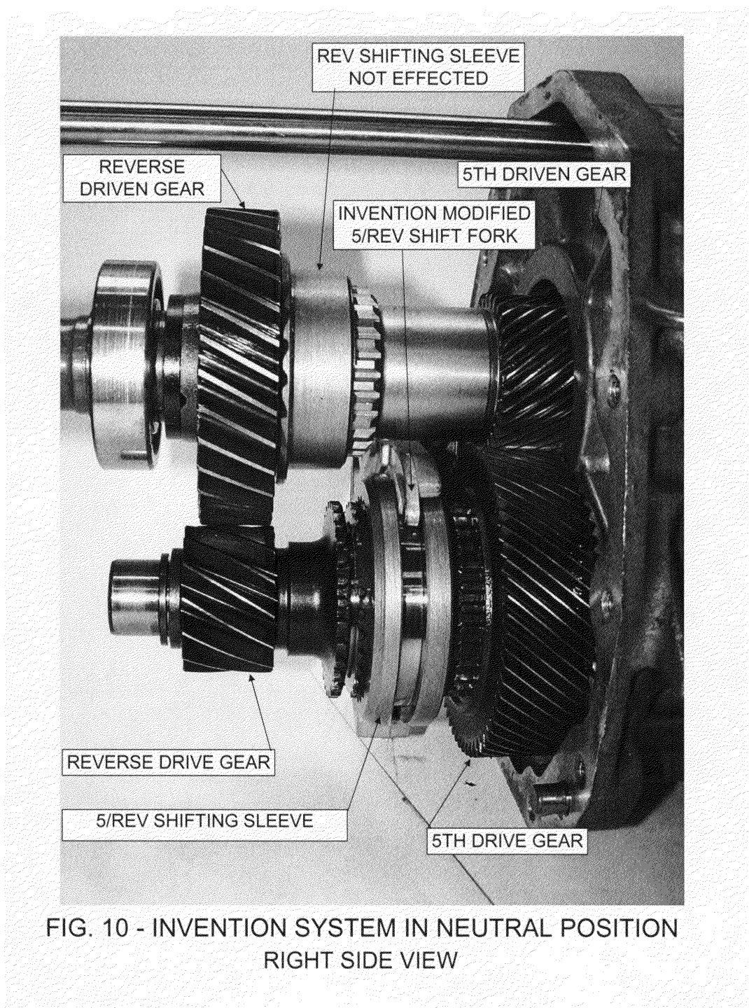

FIG. 10 illustrates the invention system in the Neutral position. The operation of the transmission in Neutral position is basically the same as the original system. With the reverse shifting sleeve now constantly engaged and the reverse driven gear fixed to the output shaft, the reverse driven gear will cause the reverse gear mesh to rotate at all times. But with the 5/Rev shifting sleeve in neutral position, the reverse drive gear is not engaged and spins freely on the countershaft.

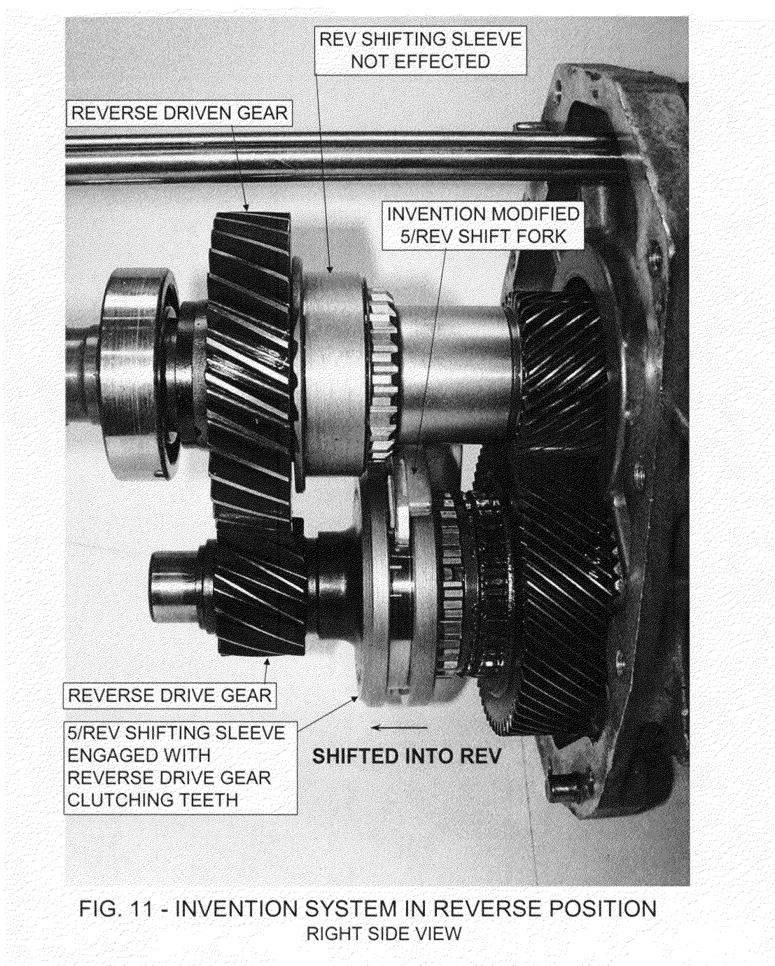

FIG. 11 provides a right side view of the invention system now shifted into the engaged reverse gear position. When shifted into reverse, the 5/Rev shift rail moves the invention modified shift fork rearward which slides the 5/Rev shifting sleeve tooth points rearward to engage the clutching teeth of the reverse drive gear. The reverse shifting sleeve on the output shaft is not affected. With the reverse position engaged, the output shaft rotation is directly connected through the reverse geartrain mesh being driven through the reverse drive gear on the counter shaft.

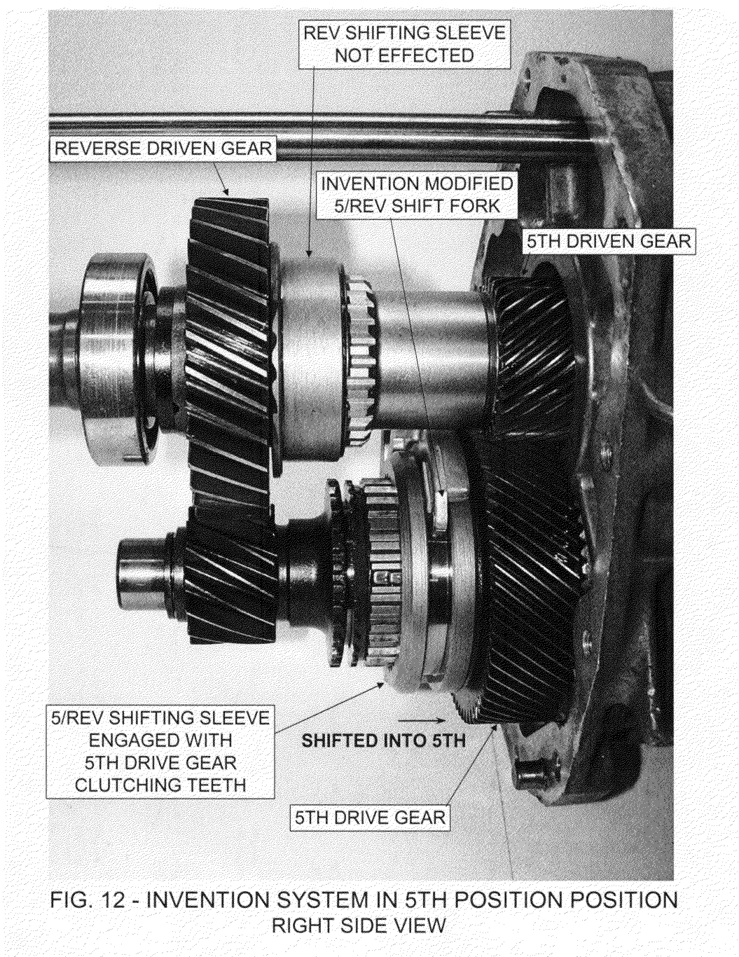

FIG. 12 provides a right side view of the invention system shifted into the 5th engaged position. When shifted into 5th, the 5/Rev shift rail moves the invention modified shift fork forward which slides the 5/Rev shifting sleeve tooth points forward to engage the clutching teeth of the 5th drive gear. The reverse shifting sleeve on the output shaft is not affected. With the 5th position engaged, the output shaft rotation is directly connected through the 5th geartrain mesh being driven through the 5th drive gear on the counter shaft.

With the original double disconnect design now reduced to only a single acting sliding sleeve, the origin of the reverse shift problem has been eliminated. The 5/Rev synchronizer assembly on the countershaft now functions as a conventional synchronizer system allowing the transmission to be easily shifted into either reverse or 5th gear positions.

I. (canceled)

II. Modification to the model T45 manual transmission double disconnect shift fork to remove or eliminate the upper section of shift fork which originally controlled the position of the reverse sliding sleeve located on the output shaft.

III. Modification to the model T45 manual transmission reverse hub located on the output shaft to add s'ring located in a machined groove added to the reverse hub.

IV. (canceled)

V. Modification to the model T45 manual transmission to provide constant engagement of the reverse driven gear and directly connect the reverse driven gear to the output shaft.
